(19) United States
(12) Patent Application Publication
(10) Pub. No.: US 2013/0328820 A1
(43) Pub. Date: Dec. 12, 2013

(54) ELECTRONIC DEVICE

(71) Applicants: Yoshiaki Kondoh, Yokohama-shi (JP); Seiji Horii, Yokohama-shi (JP)

(72) Inventors: Yoshiaki Kondoh, Yokohama-shi (JP); Seiji Horii, Yokohama-shi (JP)

(73) Assignee: KYOCERA CORPORATION, Kyoto (JP)

(21) Appl. No.: 14/001,148

(22) PCT Filed: Feb. 23, 2012
(86) PCT No.: PCT/JP2012/001230

§ 371 Date: Aug. 22, 2013

(30) Foreign Application Priority Data
Feb. 23, 2011 (JP) 2011-037425

(51) Int. Cl. G06F 3/01

(52) U.S. Cl. CPC G06F 3/016
USPC 345/173

(57) ABSTRACT

In an electronic device including a touch panel 20, a vibration unit 50 for causing the touch panel 20 to vibrate and an upper housing 10a having an opening in which the touch panel 20 is disposed, a first elastic member 60 configured to close the gap between the panel and the housing for blocking the outside air is disposed extending across the touch panel 20 and the upper housing 10a, and a second elastic member 70 is disposed over the entire circumference of the bottom peripheral portion of the touch panel 20 continuously or intermittently, between the bottom peripheral portion and a supporting member located thereunder, thereby vibration of the panel is not likely to be disturbed and dustproof and waterproof performances are improved.

### CROSS REFERENCE TO RELATED APPLICATION

This application claims priority to and the benefit of Japanese Patent Application No. 2011-037425 filed on Feb. 23, 2011, the entire contents of which are incorporated herein by reference.

### FIELD

The present invention relates to an electronic device that has a panel forming an external appearance and causes the panel to vibrate.

### BACKGROUND

Recently, as input apparatuses for electronic devices, touch panels and touch pads are widely used. As one such an input apparatuses, there is suggested an apparatus that is configured to cause a touch panel or a touch pad to bend and vibrate when the operator operates them, thereby feeding back an operational feeling to the operator's finger and the like (see, for example, Patent Document 1).

### CITATION LIST

Patent Document 1: Japanese Patent Laid-Open No. 2010-044497

### SUMMARY

In the electronic device of Patent Document 1, measures against ingress of dust and water into the device are not taken. Thus, ingress of dust and water from a gap, for example, between a touch panel and a member on which the touch panel is fixed can be considered.

The above-mentioned matter may commonly occur to an electronic device that has a panel forming an external appearance and causes the panel to vibrate. Other electronic devices that cause a panel to vibrate include, for example, an electronic device that causes a panel to vibrate by applying a predetermined electrical signal (sound signal) to transmit vibration to a part of the user's body (e.g. the external ear cartilage) contacting with the panel, and thus sound is transmitted to the user. Other electronic devices that cause a panel to vibrate include an electronic device with a function that vibrates the panel to remove water drops and stains attached thereto.

The present invention provides an electronic device that has a panel forming an appearance and causes the panel to vibrate, in which vibration of the panel is not likely to be disturbed and dustproof and waterproof performances are improved.

That is, the present invention relates to an electronic device including:

a panel;

a vibration unit configured to cause the panel to vibrate; and

a housing formed with an opening in which the panel is disposed, such that

a first elastic member configured to close the gap between the panel and the housing for blocking the outside air is disposed extending across the panel and the housing; and

a second elastic member is disposed over the entire circumference of the bottom peripheral portion of the panel continuously or intermittently, between the bottom peripheral portion and a supporting member located thereunder.

The present invention enables an electronic device that has a panel forming an appearance and causes the panel to vibrate, in which vibration of the panel is not likely to be disturbed and dustproof and waterproof performances can be improved.

### BRIEF DESCRIPTION OF DRAWINGS

FIG. 1 is a perspective view of an electronic device in accordance with an embodiment of the present invention;

FIG. 2 is an exploded perspective view of the electronic device in accordance with an embodiment;

FIG. 3 is a further exploded perspective view of the electronic device in accordance with an embodiment;

FIG. 4 is a cross-sectional view of the electronic device in accordance with an embodiment;

FIGS. 5A-5C are partial cross-sectional views of a variation of the electronic device in accordance with an embodiment;

FIG. 6 is a perspective view of an electronic device in accordance with an embodiment of the present invention;

FIG. 7 is an exploded perspective view of the electronic device in accordance with an embodiment;

FIG. 8 is a further exploded perspective view of the electronic device in accordance with an embodiment;

FIG. 9 is a cross-sectional view of the electronic device in accordance with an embodiment;

FIGS. 10A-10D are partial cross-sectional views of a variation of the electronic device in accordance with an embodiment;

FIG. 11A is an elevation view of an electronic device in accordance with an embodiment;

FIG. 11B is cross-sectional view taken from line b-b in FIG. 11A; and

FIG. 12 is a cross-sectional view of a variation of the electronic device in accordance with an embodiment.

### DESCRIPTION OF EMBODIMENTS

### First Embodiment

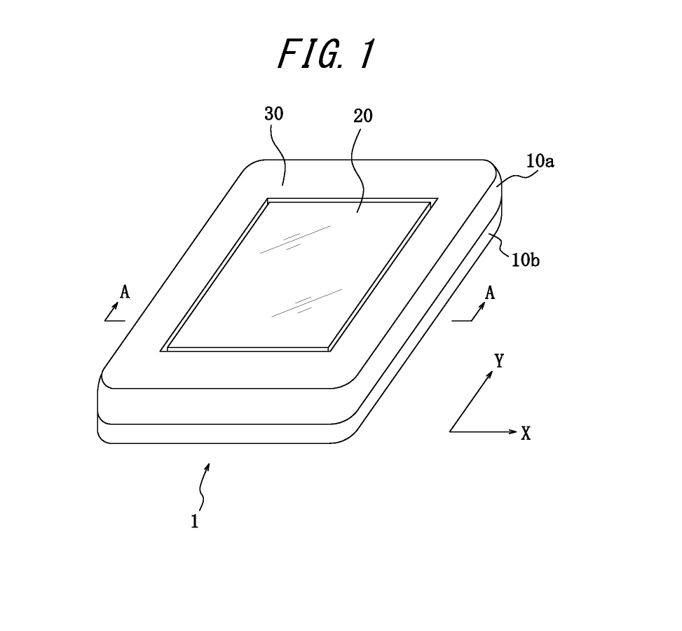

Embodiments of the present invention will now be described with reference to the accompanying drawings. FIG. 1 is a perspective view of the electronic device in accordance with a first embodiment of the present invention.

As illustrated in FIG. 1, the electronic device 1 has, in appearance, an upper housing 10a, a lower housing 10b and a touch panel 20. The “touch panel” refers to a member disposed on the front surface of a display unit, which may be configured using, for example, an LCD and the like, that is, the touch panel may be a member provided separately from the display unit.

The upper housing 10a and the lower housing 10b form a housing 10 when they are combined into one body. The gap between the upper housing 10a and the lower housing 10b is, when they are combined into one body, sealed by, for example, a rubber packing and the like, and thus an appropriate waterproof/dustproof measure is taken. It is preferable that the upper housing 10a and the lower housing 10b are configured as a case made of, for example, resin, and as such, they are formed by using a material that can withstand a certain level of shock. In the following description, a detailed description of a combined structure of the upper housing 10a and the lower housing 10b is omitted.

The touch panel 20, usually disposed on the front surface of a display unit (not illustrated), detects, on the corresponding touch face of the touch panel 20, a contact of the operator's finger, a stylus pen and the like (hereinafter referred to as merely “a contacting object”) with an object displayed on the display unit. Further, the touch panel 20 detects a position in contact with the contacting object on the touch face and sends the detected contact position to a control unit (not illustrated).

The touch panel 20 may be, for example, configured using a known type such as a resistive type, a capacitive type and an optical type. When the touch panel 20 detects a contact by a contacting object, physical contact of the contacting object with the touch panel 20 is not needed. For example, when the touch panel 20 is an optical type, the touch panel 20 detects a position where the infrared rays on the touch panel 20 are blocked by the contacting object, and thus contact of the contacting object with the touch panel 20 is not needed.

The above-described display unit displays an object such as a push button switch (push-type button switch) like, for example, a key, as an image. This object is an image that suggests a region to be contacted on the touch face of the touch panel 20 to the operator. Further, the button switch is a button, a key and the like (hereinafter referred to as merely “a key and the like”) used by the operator for input operation. The display unit is configured using, for example, a liquid crystal display panel (LCD), an organic EL display panel and the like.

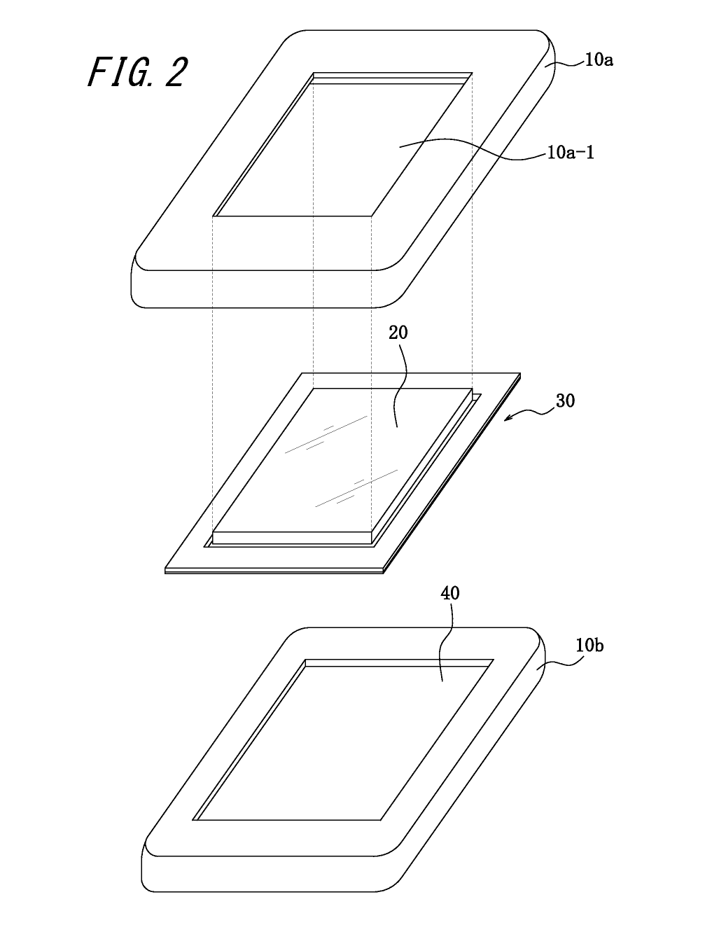

FIG. 2 is an exploded perspective view of the electronic device 1 illustrated in FIG. 1 where the electronic device is broken down into an upper housing 10a, a lower housing 10b and a touch panel assembly 30.

As illustrated in FIG. 2, the touch panel assembly 30 is inserted between the upper housing 10a and the lower housing 10b, and the touch panel 20 is disposed in the opening 10a-1 of the upper housing 10a. In addition, a display unit 40 such as an LCD is disposed in a concave portion formed on the lower housing 10b. A base plate not illustrated is disposed on the bottom of the display unit 40.

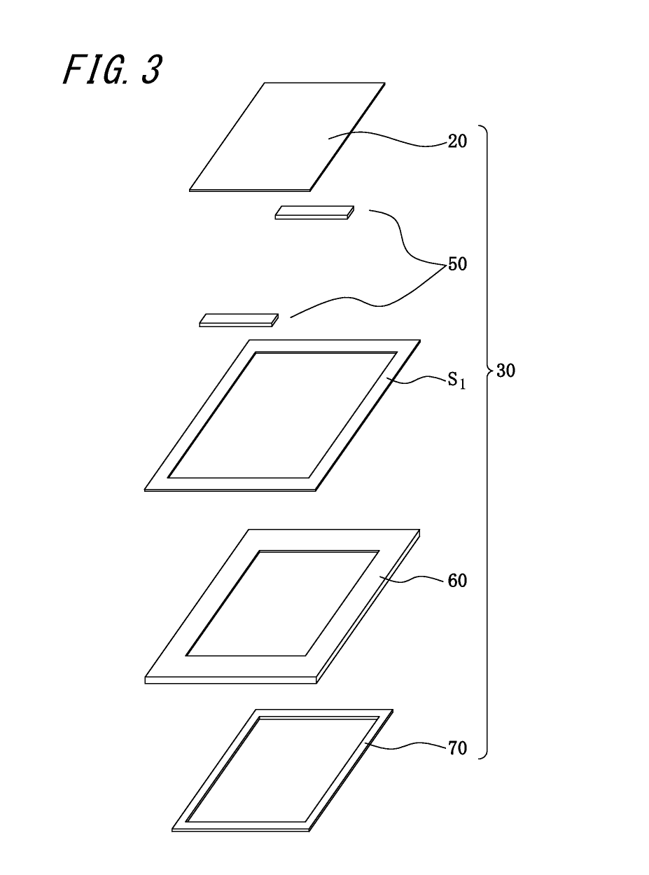

FIG. 3 is a perspective view illustrating a touch panel assembly 30 in FIG. 2 in an exploded state. Here, the touch panel assembly 30 is composed of a touch panel 20, a vibration unit 50, a first elastic member 60 and a second elastic member 70. In addition, S1 is an adhesive material for attaching the upper housing 10a to the first elastic member 60 and the adhesive material may be a waterproof double-sided tape. Moreover, the touch panel 20 and the first elastic member 60, and the first elastic member 60 and the second elastic member 70 may also be adhered respectively with an adhesive material (not illustrated).

As illustrated in FIG. 3, on the bottom of the touch panel 20, vibration units 50 are disposed in the vicinity of the upper and lower margins (the far side and this side in the figure) according to the present embodiment. The vibration units 50 may be formed of, for example, a piezoelectric element.

The vibration units 50 may be disposed not only in the vicinity of the upper and lower margins of the touch panel 20, but also in the vicinity of the left and right margins of the touch panel 20.

Moreover, the vibration units 50 generate a vibration according to a predetermined vibration pattern, thereby presenting a tactile sensation to a contacting object being in contact with the touch face. In the present embodiment, the vibration unit 50 generates a vibration based on a drive signal supplied, for example, from a control unit not illustrated.

The first elastic member 60 is a film made of flexible material such as PET (polyethylene terephthalate) and the like, and sufficiently thin, thus may slightly expands and contracts. Further, the first elastic member 60 is formed in a frame shape and is attached to the bottom of the touch panel 20, continuously or intermittently over the entire circumference of the bottom peripheral portion of the touch panel 20. Here, the bottom peripheral portion of the touch panel 20 refers to the marginal region on the bottom of the touch panel 20, and preferably to the region with a width of about 2 to 3 mm.

Further, in the region of the upper surface of the first elastic member 60 contacting with the upper housing 10a, an adhesive material S1 formed in a frame shape is provided.

Moreover, on the bottom of the touch panel 20, the second elastic member 70 formed in a frame shape is fixed over the entire circumference of the bottom peripheral portion of the touch panel 20 through the first elastic member 60. Here, the second elastic member 70 is preferably a flexile urethane foam (micro-cell urethane foam), and in addition, silicone foam and silicon rubber may be used.

In this example, the second elastic member 70 is continuously disposed over the entire circumference of the bottom peripheral portion of the touch panel 20, however, the second elastic member does not need to be disposed continuously, and may be disposed intermittently.

Next, the internal configuration of the electronic device in accordance with the first embodiment of the present invention is described in detail.

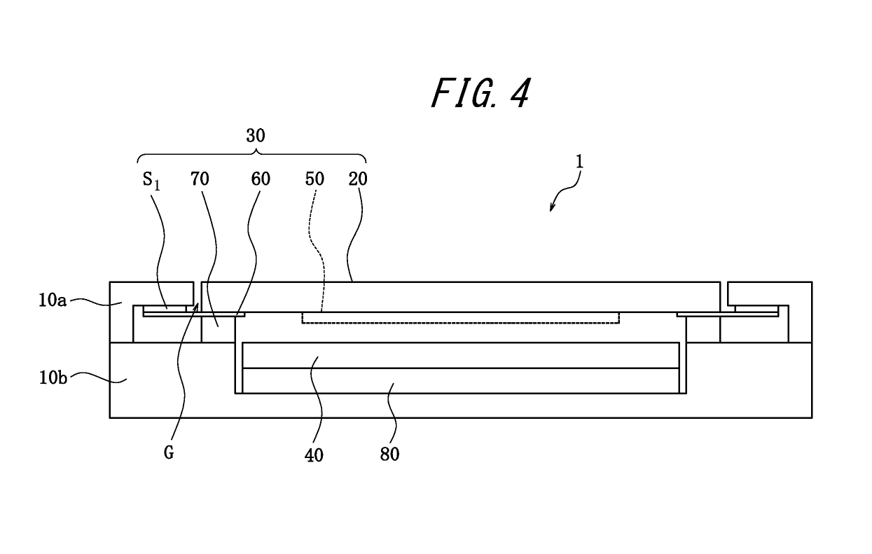

FIG. 4 is a cross-sectional view of the electronic device 1 taken from line A-A in FIG. 1. An example of the electronic device 1 having a symmetric configuration is described below. Thus, in FIG. 4, reference numerals describing the right side configuration of the figure are omitted.

As illustrated in FIG. 4, the touch panel assembly 30 is disposed in the electronic device 1 with the first elastic member 60 attached to the upper housing 10a through the adhesive material S1, and with the second elastic member 70 placed on the lower housing 10b. It is preferable that the second elastic member 70 and the lower housing 10b are also fixed by using adhesive material.

Thus, the gap G between the touch panel 20 and the upper housing 10a can be closed from underneath by the first elastic member 60 that extends across the touch panel 20 and the upper housing 10a, and as a result of that, ingress of outside air from the gap between the touch panel 20 and the upper housing 10a into the device can be reduced by the first elastic member 60, and thus a waterproof/dustproof measure to the electronic device 1 may be realized.

Further, the touch panel 20 is supported by the upper housing 10a through the first elastic member 60 and vertically movably supported by the lower housing 10b through the second elastic member 70. As a result of this, the touch panel 20 can bend and vibrate with the gap G between the upper housing 10a and the touch panel 20 as a node, resulting in less attenuation of the bending vibration thereof.

In the present embodiment, the lower housing 10b is equivalent to the supporting member. However, the supporting member is not limited to the lower housing 10b, and for example, a supporting portion extending to the bottom of the touch panel 20 may be provided on the upper housing 10a, and this supporting portion may be used as a supporting member. For another example, the widths of the concave portion of the lower housing 10b and the display unit 40 may be expanded respectively to use the display unit 40 as a supporting member, or the widths of the concave portion of the lower housing 10b and the base plate 80 may be expanded respectively to use the base plate 80 as a supporting member.

In the present embodiment, description has been given assuming that, the first elastic member 60, extending across the touch panel 20 and the upper housing 10a, closes the gap G between the touch panel 20 and the upper housing 10a. Here, the upper housing 10a may be divided into two, that is, for example, a bezel (frame-shaped member) surrounding the touch panel 20 and the body of the upper housing. When the upper housing is configured to be divided into two in this manner, the above mentioned effect may be obtained by fixing an adhesive material on the bezel.

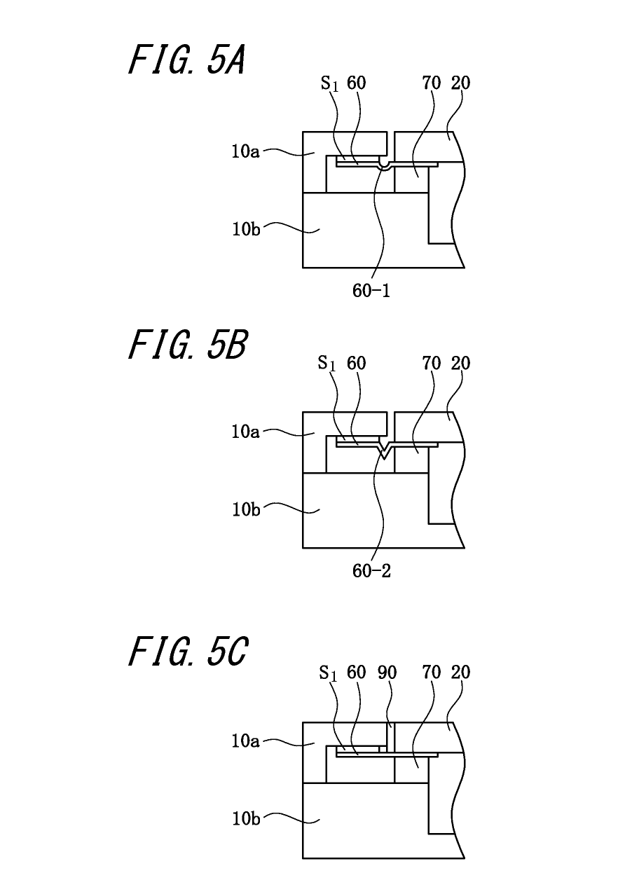

As a variation of the present embodiment, a U-shaped or a V-shaped bent portion as illustrated respectively as 60-1 and 60-2 in FIGS. 5A and 5B may be provided in the middle part of the first elastic member 60. The elastic property of the first elastic member 60 may be increased by providing such bent portions 60-1 and 60-2, thereby preventing attenuation of the bending vibration of the touch panel 20 more effectively. Also, the gap G between the touch panel 20 and the upper housing 10a may be provided with an elastic insertion material 90 such as sponge, and rubber as illustrated in FIG. 5C. In this case, attenuation of the bending vibration of the touch panel 20 may be prevented and the above-mentioned gap is closed and obscured as well. In addition, regardless of weather such elastic insertion material 90 is provided or not, it is preferable that the gap G between the touch panel 20 and the upper housing 10a is set as small as possible in appearance. However, too small gap may prevent bending vibration of the touch panel 20, and thus it is preferable to set the gap small to the extent that the bending vibration is not prevented.

According to the electronic device in accordance with the above-described present embodiment, use of the first elastic member and the second elastic member may reduce attenuation of bending vibration of the touch panel by the vibration unit and improve a waterproof/dustproof effect on the electronic device.

Further, according to the electronic device in accordance with the present embodiment, the touch panel, the vibration unit, the first elastic member, the adhesive material and the elastic member may be prepared previously as a touch panel assembly, which is, one unit. Thus, an electronic device can be assembled easily and quickly, thereby reducing a production cost.

Further, in the present embodiment, the electronic device with a frame-shaped first elastic member has been described, and the first elastic member may be attached to the entire bottom face of the touch panel. When the first elastic member is attached to the entire bottom face in this manner, dust can be prevented more reliably on the bottom, and the probability of falling of the touch panel out of the housing may be reduced.

### Second Embodiment

Next, the electronic device in accordance with the second embodiment of the present invention is described.

Whereas in the above-described electronic device 1 in accordance with the first embodiment, the first elastic member 60 is disposed so that it closes the gap between the touch panel 20 and the upper housing 10a from underneath, in the second embodiment, the first elastic member 61 is disposed so that it closes the gap G between the touch panel 20 and the upper housing 10a from above. The electronic device in accordance with the second embodiment may be substantialized basically by the same configuration as that of the electronic device described in the above-described first embodiment, except the above-mentioned points. Thus overlapping description with that given for the first embodiment is appropriately omitted.

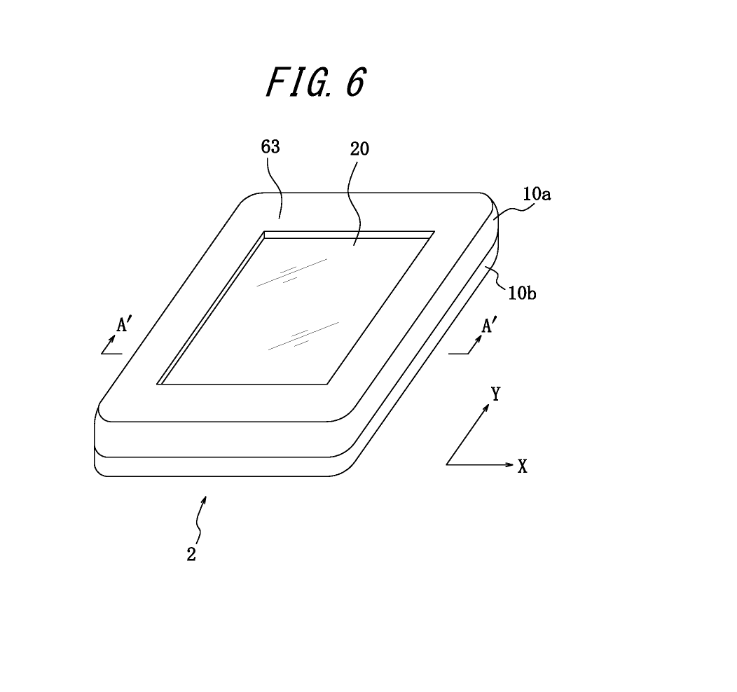

FIG. 6 is a perspective view of the electronic device 2 in accordance with the second embodiment. As illustrated in FIG. 6, the electronic device 2 in accordance with a second embodiment has the same appearance as that of the electronic device in accordance with the first embodiment, except for the first elastic member 61 disposed extending across the peripheral portion of the upper surface of the touch panel 20 and the upper surface of the upper housing so that the gap between the touch panel 20 and the upper housing 10a is closed from above.

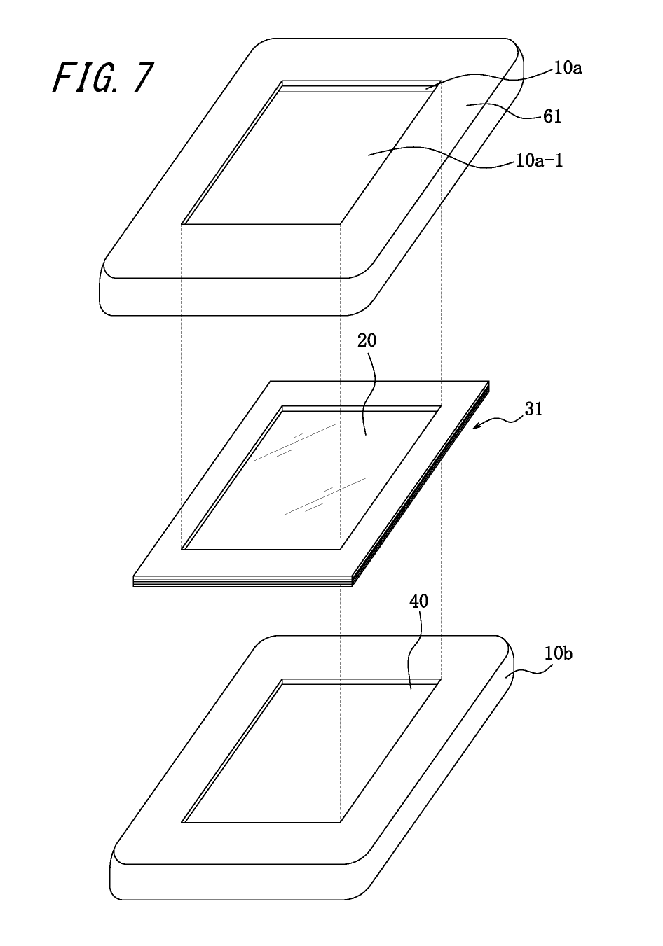

FIG. 7 is an exploded perspective view of the electronic device 2 illustrated in FIG. 6 where the electronic device 2 is broken down into an upper housing 10a, a lower housing 10b and a touch panel assembly 31.

As illustrated in FIG. 7, the touch panel assembly 31 is inserted between the upper housing 10a and the lower housing 10b, and the touch panel 20 is disposed in the opening 10a-1 of the upper housing 10a.

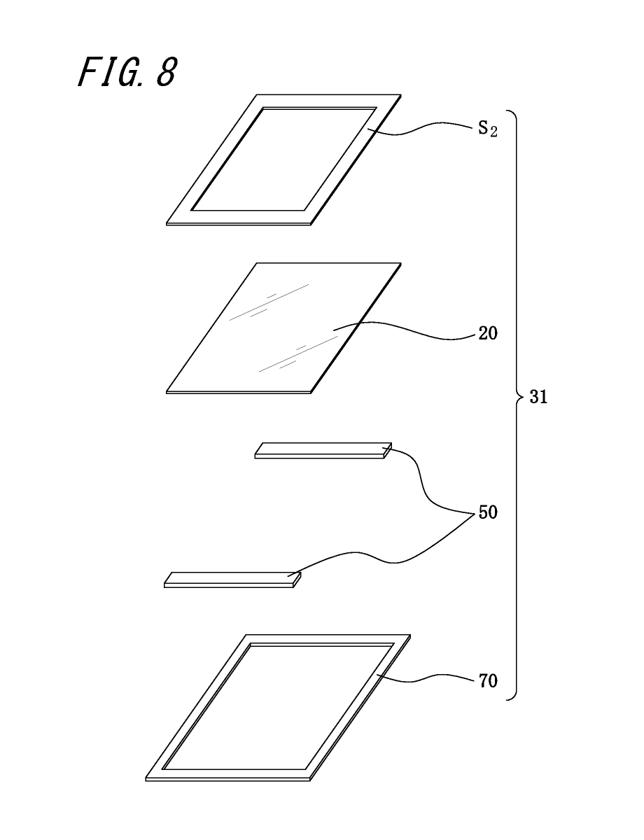

FIG. 8 is a perspective view illustrating an exploded touch panel assembly 31 illustrated in FIG. 7. Here, the touch panel assembly 31 is composed of a touch panel 20, a vibration unit 50, an adhesive material S2 and a second elastic member 70.

As illustrated in FIG. 8, the adhesive material S2 formed in a frame shape is disposed on the peripheral portion of the upper surface of the touch panel 20, over the entire circumference of the peripheral portion thereof. Here, the peripheral portion of the upper surface of the touch panel 20 refers to the marginal region on the upper surface of the touch panel 20, and preferably to the region with a width of about 2 to 3 mm. In addition, S2 is an adhesive material for attaching the touch panel 20 to the first elastic material 60, and as in the case of the first embodiment, a waterproof double-sided tape is suitable as such an adhesive material.

On the bottom of the touch panel 20, over the entire circumference of the bottom peripheral portion thereof, the second elastic member 70 is fixed continuously or intermittently with an adhesive material.

Next, the internal configuration of the electronic device in accordance with the second embodiment of the present invention is described.

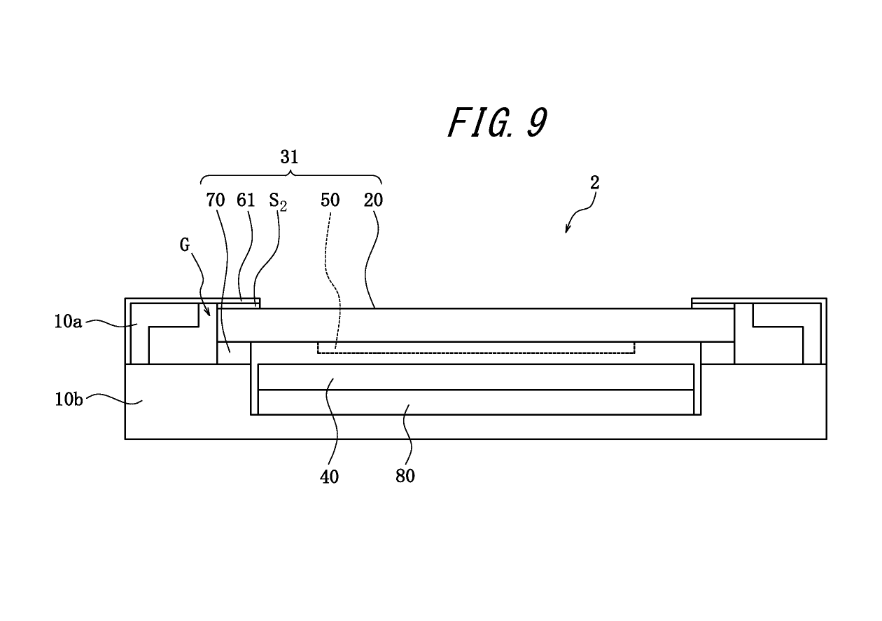

FIG. 9 is a cross-sectional view of the electronic device 2 taken from line A′-A′ in FIG. 6. As in the case of the first embodiment, an example of the electronic device 2 having a symmetric configuration is described below. Thus, illustration of the right side configuration of the electronic device 2 is omitted.

As illustrated in FIG. 9, the touch panel assembly 31 is fixed to the electronic device 2 with the touch panel 20 attached to the upper housing 10a through the first elastic member 61 and the adhesive material S2, and with the second elastic member 70 placed on the lower housing 10b.

Thus, as in the case of the first embodiment, the gap G between the touch panel 20 and the upper housing 10a can be closed from above with the first elastic member 61 that extends across the touch panel 20 and the upper housing 10a. As a result, the gap between the touch panel 20 and the upper housing 10a may be sealed with the first elastic member 61, thereby improving a waterproof and dustproof performances of the electronic device 2.

Moreover, the touch panel 20 is supported by the upper housing 10a through the first elastic member 61 and vertically movably supported by the lower housing 10b through the second elastic member 70. As a result of this, the touch panel 20 may bend and vibrate with the gap G between the upper housing 10a and the touch panel 20 as a node, resulting in almost no attenuation of the bending vibration thereof, as in the case of the first embodiment.

Incidentally, also in the present embodiment, the lower housing 10b corresponds to the supporting member. However, the supporting member is not limited to the lower housing 10b, and as in the case of the first embodiment, for example, a supporting portion extending to the upper housing 10a and the display unit 40 or the base plate 80 may be used as a supporting member.

Preferably, in the present embodiment, the first elastic member 61 may be integrated into the upper housing 10a by, for example, in-mold forming or a film forming Also, in this case, paint of the upper housing 10a may be omitted by applying a desired printing to the first elastic member 61. In the present embodiment, the first elastic member 61 is disposed over the entire upper surface and the side surface, however, the first elastic member may be disposed only, for example, on the upper surface of the upper housing 10a. Also, as in the case of the first embodiment, the upper housing 10a may be divided into, for example, a bezel (frame-shaped member) surrounding the touch panel 20 and the upper housing body, and the first elastic member 61 may be fixed to the upper surface of the bezel.

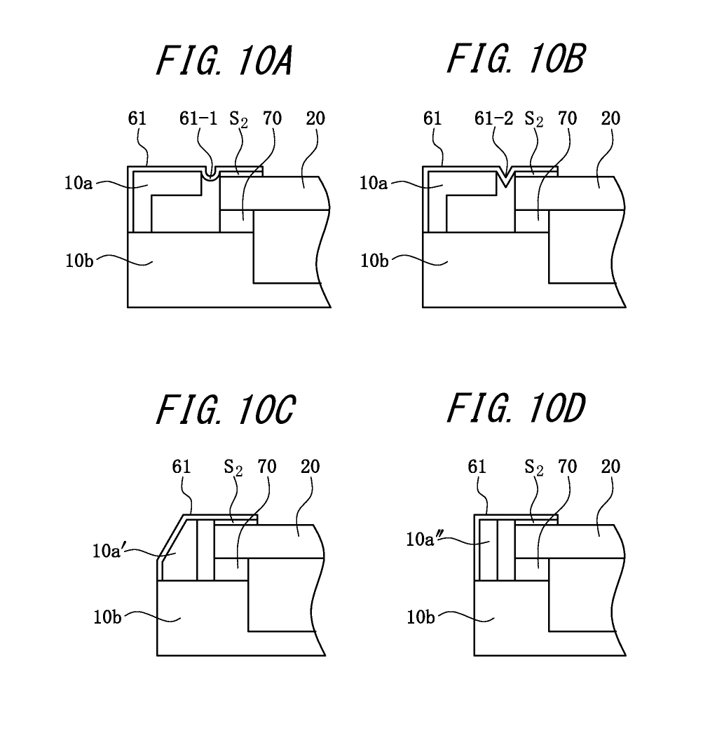

As a variation of the present embodiment, a bent portion illustrated in FIGS. 10A and 10B respectively as 60-1 and 60-2 may be provided over the entire circumference of the first elastic member 61. With such a bent portion, as in the case of the first embodiment, elasticity of the first elastic member 61 may be increased, thereby preventing the attenuation of bending vibration of the touch panel 20 more effectively.

Further, according to the present embodiment, the first elastic member 61 is supported on the upper surface of the upper housing 10a, and thus it is not necessary to use the inside portion of the housing 10a for the support. Thus the degree of freedom of the shape of the upper housing 10a may be increased. As a result thereof, as a variation of the present embodiment, the upper housing 10a may be formed into a tilted shape as illustrated in FIG. 10C, or may be formed into a narrow frame shape as illustrated in FIG. 10D.

Incidentally, as illustrated in FIGS. 10A and 10B, when the first elastic member is provided with a bent portion, it is preferable that the gap between the touch panel 20 and the upper housing 10a is set as small as possible in appearance. However, as in the case of the first embodiment, too small gap may prevent bending vibration of the touch panel 20, and thus it is preferable to set the gap small to the extent that the bending vibration is not prevented.

According to the electronic device in accordance with the above-described present embodiment, as in the case of the first embodiment, use of the first elastic member and the second elastic member may reduce attenuation of bending vibration of the touch panel by the vibration unit and improve a waterproof/dustproof effect on the electronic device.

Further, by the first elastic member being supported on the upper surface of the upper housing, the degree of freedom of the shape of the upper housing 10a is improved.

Also, according to the electronic device in accordance with the present embodiment, the touch panel, the vibration unit, the adhesive material and the elastic member may be prepared previously as a touch panel assembly, which is, one unit. Thus, as in the case of the first embodiment, an electronic device may be assembled easily and quickly, thereby reducing a production cost.

The present invention is not limited to the above-mentioned embodiments, and various modifications and variations may be made. For example, in the above-described each embodiment, an aspect in which an object is displayed on a display unit (not illustrated) disposed on the bottom of the touch panel and the touch panel detects a contact by the operator has been described. However, the present invention is not limited to such an aspect, and for example, an aspect in which no display unit is provided and an object is printed directly on the touch face of the touch panel by ink and the like is also applicable.

Also, in the above-mentioned embodiment, description has been made about the case where, by using a touch panel, a contact with the touch face of the touch panel is detected. That is, in the above-described embodiment, the touch panel is considered as a member such as, a so-called touch sensor. However, the touch panel used for the electronic device according to the present invention may be appropriately configure using any member as long as it becomes in contact with a contacting object such as an operator's finger, a stylus pen and the like.

For example, the touch panel used for the electronic device according to the present invention may be a member such as a mere “panel” that does not detect the position being in contact with a contacting object with the touch face (that is, without a sensing function). In the electronic device configured in such a manner, for example, a press detection unit configured to detect a press on the touch panel is further provided, thereby, based on the press detected by the press detection unit, determination that the touch panel has been touched may be made.

Further, in the above-mentioned embodiment, with a touch panel, a contact with the touch face of the touch panel is detected. However, the press detection unit may detect a press on the touch panel, and based on the press, determination may be made that the touch panel has been touched.

The above-described press detection unit detects a press on the touch face of the touch panel, and may be configured using, for example, any number of strain gauge sensors, piezoelectric elements and the like whose physical or electrical characteristics (strain, resistance, voltage, etc.) vary in response to the press. Alternatively, when the vibration unit is a piezoelectric element, the piezoelectric element may be used as a press detection unit. Strain of the touch panel by a press is detected by employing such a configuration, and thus a configuration in which a press on the touch panel is calculated based on the strain is considered.

For example, when the press detection unit is configured using a piezoelectric element and the like, in the piezoelectric element of the press detection unit, a voltage (voltage value), which is an electrical characteristic, varies in response to the magnitude of the load (force) (or a rate of changing the load (force) (acceleration)) on the press against the touch face of the touch panel. In this case, the press detection unit may send the voltage (voltage value (hereinafter referred to merely “data”)) to the control unit. When the press detection unit sends the data to the control unit or when the control unit detects the data from the press detection unit about the piezoelectric element, the control unit obtains the data. That is, the control unit obtains the data which is based on a press on the touch face of the touch panel. In other words, the control unit obtains the data based on a press from the press detection unit. Then, when the data based on a press satisfies a predetermined standard, the control unit determines that a contact has been made, and may generate a predetermined vibration. Here, the above-mentioned standard may be appropriately set based on the load characteristics of an intended push button when pushed.

Such a press detection unit may be configured correspondingly to the contact detection type of the touch panel. For example, in the case of a resistive type, the resistance according to the size of contact area is associated with the load (force) of the press against the touch face of the touch panel, thereby forming a press detection unit without using a strain gauge sensor, a piezoelectric element and the like. Alternatively, in the case of a capacitive type, the capacitance is associated with the load (force) of the press against the touch face of the touch panel, thereby forming a press detection unit without using a strain gauge sensor, a piezoelectric element and the like.

For such a press detection unit, various configurations may be considered in accordance with the contact detection type of the touch panel. For example, in the case of a resistive type, the resistance according to the size of contact area is associated with the load (force) of the press against the touch face of the touch panel, thereby forming a press detection unit without using a strain gauge sensor, a piezoelectric element and the like. Alternatively, in the case of a capacitive type, the magnitude of capacitance is associated with the load (force) of the press against the touch face of the touch panel, thereby forming a press detection unit without using a strain gauge sensor, a piezoelectric element and the like.

Also, the vibration unit may be formed by using any number of piezoelectric vibrators, by providing a transparent piezoelectric element over the whole surface of the touch panel, or by rotating an eccentric motor once per one cycle of a drive signal. Further, the press detection unit and the vibration unit may, when they are formed by using a piezoelectric element, be formed as a press detection and vibration unit by sharing the piezoelectric element. This is because a piezoelectric element generates a voltage when a pressure is applied and deforms when a voltage is applied.

Also, as described above, the vibration unit may be configured to generate, when the voltage (voltage value (data)) of a piezoelectric element serving as a press detection unit satisfies a predetermined standard, a vibration by driving the piezoelectric element. Here, the point of time when the magnitude of voltage (voltage value (data)) of a piezoelectric element satisfies a predetermined standard may be the point of time when the voltage value (data) reaches a predetermined standard value, when the voltage value (data) exceeds a predetermined standard value, or when a voltage value (data) equal to the predetermined standard value is detected.

The above-described embodiment has been described on the assumption that the touch panel is superimposed on the upper surface of the display unit. The electronic device according to the present invention need not be configured in such a manner, and the touch panel and the display unit may be disposed away from each other. However, with a configuration in which the touch panel is superimposed on the upper surface of the display unit, the operator may recognize easier the correspondence relation among an image to be displayed, a region where an operation input is detected and a generating vibration.

In addition, the display unit and the touch panel according to the above-described embodiment may be formed into one apparatus by providing a common base plate having both display unit function and contact detection unit function. Examples of a configuration in which both display unit function and contact detection unit function are integrated include a configuration in which a plurality of photoelectric conversion elements such as photo diodes are mixed regularly into a group of pixel electrodes arranged in a matrix on a liquid crystal panel. Such the device displays images with a liquid crystal panel structure, and on the other hand, detects the position that has been touched by reflecting the backlight for the liquid crystal display with a tip of the pen that touches a desired position on the surface of the panel for input and by receiving the reflected backlight with the peripheral photoelectric conversion elements.

The vibration unit may be configured to cause the touch panel to vibrate indirectly by causing the electronic device to vibrate based on the vibration motor (eccentric motor), or may be configured to cause the touch panel to vibrate directly by providing the touch panel with a piezoelectric element.

In addition, in the above-mentioned embodiment, a mobile telephone terminal that has a touch panel with a sensing function and feeds back an operational feeling has been described, however, the present invention is not limited thereto. The electronic device in accordance with the third embodiment of the present invention will now be described below.

For example, the electronic device in accordance with the present invention may be configured to cause the panel to vibrate by applying an electrical signal in response to a predetermined sound signal to the piezoelectric element attached to the panel such as a cover panel for protecting a touch panel and a display unit. In such an electronic device, sound may be transmitted to the user even when a part of the user (e.g. the external ear cartilage) contacts with the panel vibrated.

The mobile telephone 100 described below is provided as an example of an electronic device in accordance with the third embodiment of the present invention, and thus is not limited to the illustrated configuration. The configuration of the mobile telephone 100 may be changed appropriately to the extent that the present invention is applicable without any problems.

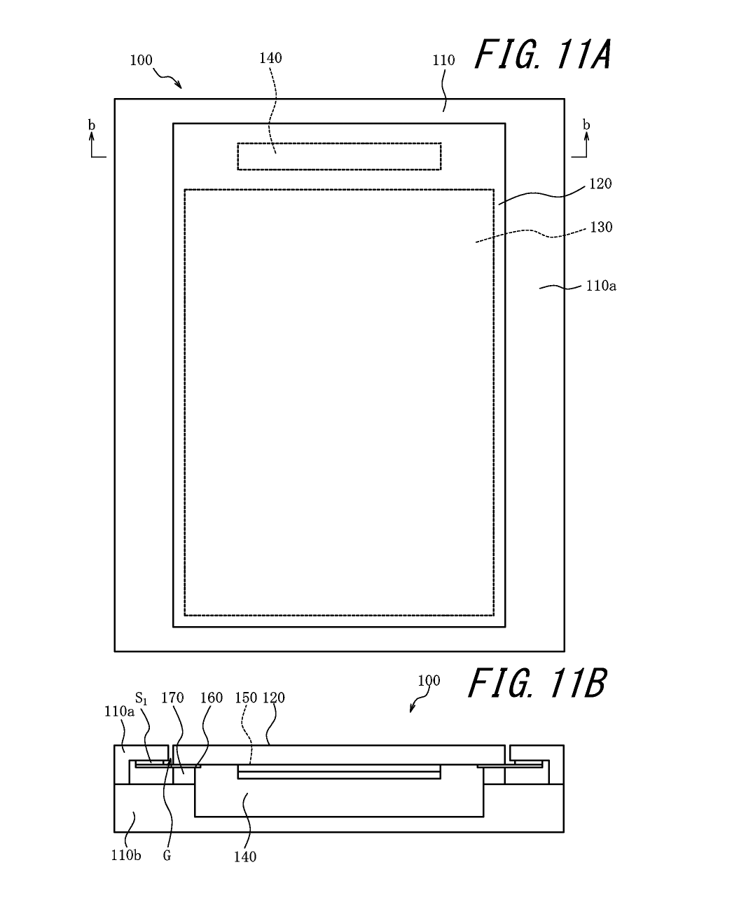

FIGS. 11A and 11B illustrate the electronic device in accordance with the third embodiment of the present invention. FIG. 11A is an elevation view and FIG. 11B is a cross-sectional view taken from line b-b in FIG. 11A.

As illustrated in FIGS. 11A and 11B, the mobile telephone 100, as an electronic device in accordance with the third embodiment of the present invention, has a housing 110, a panel 120, a display unit 130 and a piezoelectric element 140. The piezoelectric element 140 is attached to the panel 120 with a bonding member 150. Each of the panel 120, the display unit 130 and the piezoelectric element 140 is substantially rectangular. The region of the piezoelectric element 140 contacting with the bonding member 150 may be almost whole surface of one side of the piezoelectric element. In this case, comparing with the case where, for example, only both ends of the piezoelectric element are the region contacting with the bonding member, the vibration of the piezoelectric element 140 is transmitted more efficiently to the panel 120, and the panel 120 may be bent and vibrated with a strength that is strong enough not to cause attenuation even when the panel 120 contacts with a human body.

As illustrated in FIG. 11A, the display unit 130 is disposed almost in the center of the panel 120 in the short direction thereof. The piezoelectric element 140 is disposed, apart from the edge in the longitudinal direction of the panel 120 by a predetermined distance, in the vicinity of the edge, and with the longitudinal direction of the piezoelectric element 140 along the short side of the panel 120. The display unit 130 and the piezoelectric element 140 are disposed side by side, parallel to the internal side face of the panel 120. For example, for the structure in which the panel 120 and the display unit 130 are not superimposed each other, the piezoelectric element 140 may be disposed in the middle part of the panel 120. When the piezoelectric element 140 is disposed in the middle part of the panel 120, vibration of the piezoelectric element 140 is transmitted evenly to all over the panel 120, and the user can recognize the sound even if he/she is in contact with various positions of the panel 120 through his/her ear. Incidentally, as in the case of the above-described embodiment, a plurality of piezoelectric elements may be mounted.

As illustrated in FIGS. 11A and 11B, the housing 110 has an upper housing 110a and a lower housing 110b. The hard portion 110a may be formed of a material such as resin and the like.

In the case of a touch panel, the panel 120 detects that a finger, a pen or a stylus pen is in contact with the touch panel. The detection type of the touch panel may be any type including a capacitive type, a resistive type, a surface acoustic wave type (or an ultrasonic wave type), an infrared type, an electromagnetic induction type and a load detection type. The panel 120 may be a protective panel for protecting the display unit 130. Further, the panel 120 may be made of, for example, a glass or a synthetic resin and may be in the form of a plate.

The display unit 130 is a display device such as a liquid crystal display, an organic EL display or an inorganic EL display.

The piezoelectric element 140 is an element that, upon applying a voltage, expands and contracts according to the electromechanical coupling coefficient of component. The piezoelectric element 140 may be a unimorph, a bimorph or a stacked type piezoelectric element. The stacked type piezoelectric element includes a stacked type bimorph element in which bimorphs are stacked (e.g. 16 or 24 layers are stacked). In the case of a stacked type piezoelectric element, it is configured by, for example, a stack structure of a plurality of dielectric layers of PZT (lead zirconium titanate) and electrode layers disposed between the dielectric layers.

The bonding member 150 may be an adhesive having a thermosetting property or an ultraviolet curable property, a double-side tape and the like. For example, an optically clear resin, which is a clear acrylic ultraviolet cure adhesive may be used.

The first elastic member 160 is made of flexible material such as PET (polyethylene terephthalate) and the like, and sufficiently thin, thus may slightly expands and contracts. Further, the first elastic member 160 may be formed in a frame shape and is attached to the bottom of the touch panel 20, continuously or intermittently, over the entire circumference of the bottom peripheral portion of the touch panel 120.

Also, in the region of the upper surface of the first elastic member 160 in contact with the upper housing 110a, an adhesive material S1 formed in a frame shape may be provided.

On the bottom of the touch panel 120, the second elastic member 170 formed in a frame shape is fixed over the entire circumference of the bottom peripheral portion of the touch pane 120 through the first elastic member 160. Here, the second elastic member 170 is preferably a flexile urethane foam (micro-cell urethane foam), or, silicone foam or silicon rubber may be used.

In this example, the second elastic member 170 is continuously disposed over the entire circumference of the bottom peripheral portion of the panel 120, however, the second elastic member does not need to be disposed continuously, and may be disposed intermittently.

As illustrated in FIGS. 11A and 11B, according to the above-mentioned mobile telephone 100, the gap G between the panel 20 and the upper housing 110a may be closed by the first elastic member 160 extending across the panel 120 and the upper housing 110a from underneath, and as a result of this, ingress of outside air from the gap between the panel 120 and the upper housing 110a into the device may be reduced by the first elastic member 160, and thus a waterproof/dustproof measure may be taken to the mobile telephone 100.

Further, the panel 120 is supported by the upper housing 110a through the first elastic member 160 and vertically movably supported by the lower housing 110b through the second elastic member 170. As a result of this, the panel 120 causes less vibration attenuation.

In the mobile telephone 100 having the above-mentioned configuration, sound may be transmitted to the user even if a part of the user's body contacts with the panel 120 vibrated by expansion and contraction of the piezoelectric element 140.

The piezoelectric element 140 expands and contracts (curves) in the longitudinal direction based on an electrical signal output, for example, from the control unit not illustrated. The piezoelectric element 140 is attached to the panel 120 with the bonding member 150, and thus the panel 120 vibrates along with expansion and contraction of the piezoelectric element 140. The panel 120 causes not only the region where the piezoelectric element 140 is mounted on but also the region away from the above-mentioned region to vibrate. The panel 120 vibrates, at a certain moment, so that a portion where amplitude of vibration is relatively large and a portion where amplitude of vibration is relatively small will be randomly distributed all over the panel. That is, a plurality of wave vibrations are detected all over the panel.

In the above-mentioned mobile telephone 100, a predetermined electrical signal (sound signal) is applied to the piezoelectric element, thereby causing the panel such as a cover panel that protects a touch panel and a display unit to vibrate, and transmitting sound to the user when a part of the user's body (e.g. the external ear cartilage) contacts with the vibrating panel.

The sound output by the panel of the above-mentioned mobile telephone 100 may be the voice of a corresponding party or music melody including ringing melody or music. As for the music melody, it may be played based on the music data stored in the internal memory or may be the music data that is stored in the external server and the like and played through the network.

When the sound is output based on the vibration of the panel caused by expansion and contraction of the piezoelectric element, usually the low-tone range is difficult to be heard when compared to the high-tone range. Thus, an amplifier may be controlled so that only the low-tone range will be amplified.

When sound is transmitted to the user through vibration of the panel and mounting a dynamic speaker separately is not needed, an opening (sound emitting port) for sound transmission is not needed to be formed in the housing, thus a waterproof/dustproof structure of the electronic device being simplified. Incidentally, a dynamic speaker may be mounted separately. In this case, a sound emitting port of the dynamic speaker may be closed by a waterproof sheet such as, for example, Gore-Tex™ and the like that passes the gas but not liquid.

The piezoelectric element causes not only the region of the panel where the piezoelectric element is mounted on but also the region away from the region of the panel where the element is mounted on to vibrate. Thus the user may bring his/her ear into contact with any position on the panel to listen to the sound. Here, a panel having an area larger than the user's ear is adopted, and the user brings his/her ear into contact with the electronic device having a panel of almost the same size as the user's ear or a panel that is larger than the user's ear so that the entire ear will be covered, and thus entry of the surrounding sound (noise) into the ear canal may be reduced and the sound output from the electronic device may be heard as well. The region of the panel to be vibrated may be larger than a region with a length equivalent to the distance from the helix to the tragus and to the antitragus and a width equivalent to the distance from the crus helicis to the antihelix. The average ear size, for example, of Japanese, can be known with reference to “Japanese Body Dimension Database (1992-1994)” by Research Institute of Human Engineering for Quality Life (HQL). In addition, usually a panel produced with reference to the Japanese ear size may be applicable also to foreigners.

The above-mentioned mobile telephone 100 may transmit sound to the user by vibration through a part of the user's body (e.g. the external ear cartilage), and in comparison with a dynamic speaker, less sound is transmitted around through vibration of the air, thus is suitable for listening, for example, to recorded messages in a train and the like.

Moreover, the above-mentioned mobile telephone 100 transmits sound through vibration of the panel 120, and for example, even if the user wears earphones or headphones, the user may listen to the sound through the earphones or headphones by bringing them into contact with the electronic device.

Also, in the above-mentioned mobile telephone 100, the display unit 130 and the piezoelectric element 140 may be disposed in parallel next to each other on the inside face of the panel 120. When the display unit 130 is mounted on the panel 120, the rigidity of the lower portion (the lower side in FIG. 11A) of the panel 120 increases, and thus the upper portion (the upper side in FIG. 11A) of the panel 120 on which the piezoelectric element 140 is attached can be vibrated more than the lower portion of the panel 120. Therefore the vibration of the panel 120 can be transmitted efficiently to the user.

Incidentally, when the panel vibrating in this manner is contacted with the human body and transmits sound, the voltage applied to the piezoelectric element may be set higher than that applied to the piezoelectric element mounted on a normal, what is called, a panel speaker. This is due to the fact that the supporting structure of the panel to the housing is substantially different. For example, in the case of a panel speaker disclosed in the Japanese Patent Laid-Open No. 2010-114866, the panel itself does not deform significantly, and is supported by the housing at the longitudinal ends thereof, with a film member, an expandable rubber material, a spring member and the like so that the whole panel will move as a unit in the panel thickness direction. On the other hand, in the above-mentioned mobile telephone 100, the whole periphery of the panel 120 is attached to the housing 110 by the first elastic member 160 and the second elastic member 170 and supported thereby. That is, the panel 120 of the mobile telephone 100 is, compared to the panel of the panel speaker described in the above-mentioned document, tightly fixed to the housing. In other words, for the first elastic member 160 and the second elastic member 170 that support the entire circumference of the panel 120, in comparison with a film member, an expandable rubber member and a spring member and the like that hold a so-called panel speaker, as mentioned above, there is selected a material with an elasticity to allow the panel to vibrate so that a portion where amplitude of vibration is relatively large and a portion where amplitude of vibration is relatively small are randomly distributed over the panel. That is, the panel itself is not to be deformed and to move in parallel with a plate-thickness direction as one unit. Thus the voltage applied to the piezoelectric element 140 of the mobile telephone 100 may be larger than that usually applied to the piezoelectric element mounted on a so-called panel speaker.

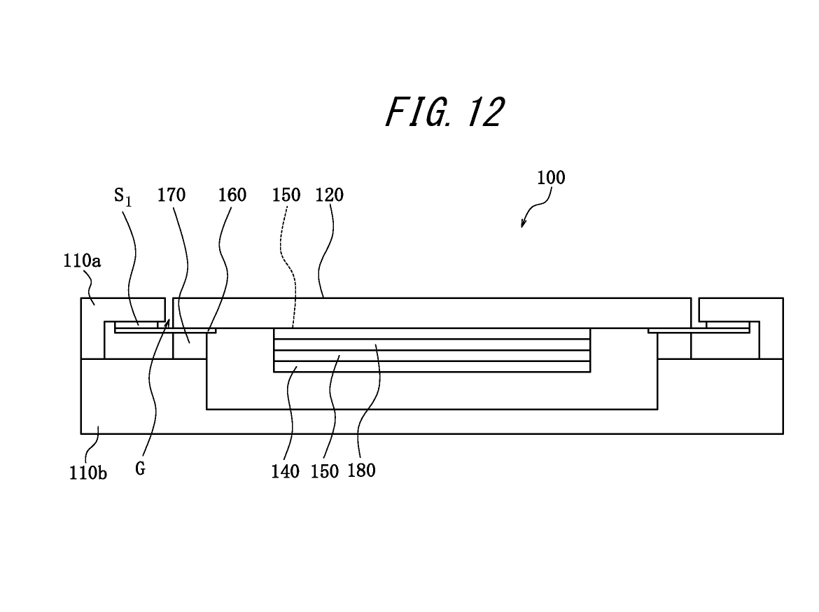

The mobile telephone 100 has been described above. The mobile telephone 100 is not limited to the above-described configuration, and various modifications are available for configuration. FIG. 12 is a view illustrating a variation of the electronic device in accordance with the third embodiment of the present invention. FIG. 12 is a cross-sectional view seeing from the direction as with that of FIG. 11B.

As illustrated in FIG. 12, an intermediate member 180 may be disposed between the piezoelectric element 140 and the panel 120. In this case, the piezoelectric element 140 and the intermediate member 180 may be bonded by the bonding member 150 and further, the intermediate member 180 and the panel 120 may be bonded by the bonding member 150. The bonding member 150 may be the above-mentioned adhesive or double-sided tape.

The intermediate member 180 may be, for example, a resin plate, a plate or a resin plate containing glass fiber. The intermediate member 180 is disposed between the piezoelectric element 140 and the panel 120, thereby, for example, when an external force is applied to the panel 120, allowing to reduce the probability of damaging the piezoelectric element by the external force being transmitted thereto. Further, disposal of the intermediate member 180 between the piezoelectric element 140 and the panel 120 may reduce the resonance frequency of the panel 120 and improve the acoustic property of low-frequency band. Incidentally, instead of the intermediate member 180, a disc-shaped weight may be attached to the piezoelectric element 140 with the bonding member 150. Thus, the panel vibration attenuation is not likely to occur even if the human body contacts with the panel hardly.

Further, in the above-mentioned mobile telephone 100, the piezoelectric element is attached to the panel. However, it may be attached to other places. For example, the piezoelectric element may be attached to a battery lid covering a battery. The battery lid is usually attached to a face that differs from a panel in the mobile telephone, and in such a configuration, the user may listen to the sound by bringing a part of his/her body (e.g. ear) into contact with the face that differs from the panel.

The above-mentioned electronic device for transmitting sound to the user through a part of the user's body (e.g. the external ear cartilage) may be an electronic device that transmits both the sound transmitted through a part of the user's body contacting with a vibrating panel (sound conducted through the human body) and the air vibration near the panel caused by the vibration of the panel (air-conducted sound).

A plurality of embodiments of the present invention have been described above, and it is obvious that each configuration of the embodiments may appropriately be combined.

### REFERENCE SIGNS LIST

1 electronic device
10a, 10a′, 10″ upper housing
10b lower housing
10a-1 opening
20 touch panel
30, 31 touch panel assembly
40 display unit
50 vibration unit
60, 61 first elastic member
60-1, 61-1 bent portion (U-shaped)
60-2, 61-2 bent portion (V-shaped)
70 second elastic member
80 base plate
90 insertion material
100 mobile telephone
110 housing
110a upper housing
110b lower housing
120 panel
130 display unit
140 piezoelectric element
150 bonding member
160 first elastic member
170 second elastic member
180 intermediate member
S1, S2 adhesive material
G gap

1. An electronic device comprising:
a panel;
a vibration unit configured to cause the panel to vibrate; and
a housing formed with an opening in which the panel is disposed, wherein
a first elastic member configured to close the gap between the panel and the housing for blocking the outside air is disposed extending across the panel and the housing; and
a second elastic member is disposed over the entire circumference of the bottom peripheral portion of the panel continuously or intermittently, between the bottom peripheral portion and a supporting member located thereunder.

2. The electronic device according to claim 1 wherein the panel is of a size covering an entire ear of a user.
